(19) United States
(12) Patent Application Publication
(10) Pub. No.: US 2010/0324757 A1
(43) Pub. Date: Dec. 23, 2010

(54) Method and Device for Optimizing the Deceleration Point of a Holding Circuit

(75) Inventors: Francois Hoofd, Toulouse (FR); Emmanuel Dewas, Toulouse (FR); François Coulmeau, Seilh (FR)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: THALES, Neuilly-sur-Seine (FR)

(21) Appl. No.: 12/821,914

(22) Filed: Jun. 23, 2010

(30) Foreign Application Priority Data
Jun. 23, 2009 (FR) 09 03039

(51) Int. Cl. G06F 19/00; G01C 21/00

(52) U.S. Cl. 701/3

(57) ABSTRACT

A method for optimizing the computation of the position of the braking point on the approach to a holding circuit for aircraft is provided. The method comprises computing the optimal position of the theoretical deceleration point allowing the aircraft to pass from its current speed to the maximum speed authorized at the entry point and of the theoretical deceleration distance, computing a trajectory portion forming a turn allowing the aircraft to enter the holding circuit and the position of the point of the start of the turn, computing a point for anticipating the turn, making it possible to take into account the banking rate of the aircraft, computing a margin, and computing the start-of-braking point, situated at a distance.

### CROSS-REFERENCE TO RELATED APPLICATIONS

This application claims priority to foreign Patent Application FR 09 03039, filed on Jun. 23, 2009, the disclosure of which is incorporated herein by reference in its entirety.

### FIELD OF THE INVENTION

The present invention relates to the field of holding circuit insertion procedures for aircraft. More particularly the field of the invention applies to methods for optimizing the aircraft's deceleration phase with the objective of inserting itself best into any type of holding circuit, generally situated in proximity to an airport.

### BACKGROUND OF THE INVENTION

The growth of automation in avionics, both civilian and military, is leading crews to make ever more use of electronic systems, and to have ever less direct influence on the aircraft's primary piloting controls. This automation makes it possible to decrease piloting risks and to standardize notably conventional flight procedures.

This trend has been accentuated with the generalization of flight management systems such as FMS, the acronym standing for Flight Management System.

A flight management system comprises various functional components which allow the crew to program a flight using a navigation database. The system then computes a lateral and vertical trajectory making it possible to reach the destination of the flight plan. These computations are based on the characteristics of the airplane and data provided by the crew and the environment of the system. The positioning and guidance functions collaborate to help the aircraft to remain on this trajectory.

The interface functions for interfacing with the crew and with the ground make it possible to put a human into the navigation loop since he alone is responsible for the progress of the flight.

In a flight management system, the pilot programs his climb or descent procedure into his FMS system. Certain procedures contain holding circuits situated in proximity to an airport making it possible to fly a trajectory preceding a landing or following a takeoff.

The air traffic controller, also called ATC the acronym standing for “Air Traffic Control,” generally gives a start-of-approach time to a crew of an aircraft so that the latter applies the approach procedure at the opportune moment. It may happen that the traffic around an airport is saturated, the traffic and/or the congestion of the runways not making it possible to satisfy a landing at the initially indicated time.

Certain situations then lead the air traffic controller to ask certain aircraft to fly a holding circuit for a duration deduced from the time of final approach to be performed. The approach time generally being denoted SAT, standing for “scheduled approach time,” this resulting in an exit time for leaving the holding circuit. To satisfy the flight conditions of a holding circuit in complete safety, functions are provided by the “Arinc 424” standard in certain terminal procedures, these functions are generally called “HOLD functions.” They make it possible notably to manage the holding of aircraft for a predetermined duration in a holding circuit. Conventional aircraft flight management means such as an FMS, the acronym standing for “Flight Management System,” make it possible, within this framework, to manage an exit time for leaving the holding circuit so as to commence the landing procedure.

More often than not the holding circuits have the form of a substantially helical trajectory comprising a certain number of portions of trajectories, whose 2D projections at constant altitude represent racetrack shapes, on which the aircraft climbs or descends in a spiral.

In aeronautical terminology these racetracks are also called HOLDs and they possess notably geometric characteristics specific to the aircraft. The trajectory of a holding circuit is generally generated automatically on the basis of the computer of an FMS. The pilot enters the airplane parameters so as to compute the characteristics of the HOLD which will be flown.

In the subsequent description either the substantially helical 3D trajectory portion whose 2D projection forms a racetrack or the 2D projection itself forming a racetrack, will be called a HOLD.

The aircraft enters and leaves the HOLD generally through a lock-on point belonging to the HOLD. In aeronautical terminology, it is also said that a point is sequenced from the point of view of the computer of the FMS when it is traversed by the aircraft.

In practice, a holding racetrack is defined in the flight plan of the FMS. It is said that it is optional insofar as it is not predicted to be “flown” as long as the aircraft is not sufficiently close to the lock-on point.

Generally the HOLD is taken into account in the flight plan at the last moment, that is to say in proximity to the point from which it is necessary to decelerate toward the speed of the HOLD so as to be capable of guiding the aircraft onto the trajectory of the HOLD.

A problem encountered in this type of aerial procedure is to compute the position of the point from which the HOLD is taken into account while avoiding forcing the aircraft to decelerate too late or else to decelerate too early.

Until recently, the entry trajectory to a holding circuit remained identical whether or not the circuit is predicted to be flown. Indeed, aircraft routinely crossed the lock-on point to enter the HOLD.

With the introduction of the DO236B standard of the RTCA, the acronym standing, in aeronautical terminology, for “Radio Technical Commission for Aeronautics,” new procedures for entering racetracks have been defined, which make it possible to avoid routinely over-flying the lock-on point of the HOLD.

Generally, a racetrack is a predefined trajectory portion. It is flown solely if the air traffic control imposes it at the moment when the aircraft arrives in proximity to the HOLD. These HOLDs are flown with reduced speeds.

By default, it is therefore preferable to ignore the HOLD in the computations of approach trajectory and associated predictions, as long as the aircraft does not enter the zone where it becomes necessary to decelerate in order to comply with the speed in question.

The part of the trajectory upstream of the lock-on point is not flown at the same speed according to whether the holding circuit is predicted to be “not flown” or “flown.”

Furthermore, the lateral trajectory is then also modified according to whether the aircraft does or does not fly the holding circuit.

A positioning of the deceleration point in proximity to the HOLD on the trajectory computed without taking into account the holding circuit in the flight plan can produce the consequence that the aircraft will not be able to decelerate in time if the HOLD is finally taken into account too late. In this case, the aircraft arriving too quickly at the turn, may exit its computed trajectory.

A simple solution can consist in positioning the deceleration point in a conservative manner, that is to say far upstream of the lock-on point so as to avoid conflict. On the other hand this solution leads to slowing down too early, this being penalizing for the crew and not complying with the specifications of aircraft manufacturers.

The problem is currently not solved.

### SUMMARY OF THE INVENTION

The invention makes it possible to alleviate the aforesaid drawbacks.

Embodiments of the present the invention advantageously determine the place where the deceleration must be performed in order to reach the maximum speed authorized in the HOLD when an air traffic control directive is received late by the aircraft. Embodiments of the present the invention also compute the position of the point while making it possible to fly the entry transition portion.

One embodiment of the present invention provides a method for optimizing the computation of the position of the braking point on the approach to a holding circuit for aircraft, the holding circuit comprising an authorized maximum speed for the aircraft and a theoretical entry point, the aircraft approaching, at a first speed, according to a predefined trajectory intercepting the entry point of the holding circuit. The method comprises:
a first step comprising the computation of the optimal position of the theoretical deceleration point allowing the aircraft to pass from its current speed to the maximum speed authorized at the entry point while maintaining its trajectory so as to reach the entry point, the distance between the deceleration point and the entry point to the HOLD being called the deceleration distance;
a second step comprising the computations:
   of a trajectory portion forming a turn allowing the aircraft to enter the holding circuit without necessarily passing through the entry point, and
   of the position of the point of the start of the turn, the distance between the point of the start of turn and the entry point of the HOLD being denoted TAD; and
a third step of computing the position of a point for anticipating the turn, making it possible to take into account the banking rate of the aircraft, the distance between the point for anticipating the turn and the start-of-turn point being denoted RAD.

Advantageously, a fourth step of computing a margin expressed as a distance taking into account the real-time computation speed of the computers of the avionics system.

Advantageously, a fifth step of computing the start-of-braking point, situated at a distance (D_{braking}) from the entry point:

D_{braking}=MAX{TAD+RAD+m arg e;D_{decéleration}}

Advantageously, a sixth step of generating a new flight plan portion joining the start-of-braking point to a point of the HOLD.

Advantageously, the second step comprises the computation of the radius of curvature of the turn for joining up with the HOLD as a function of imposed constraints.

Advantageously, the imposed constraints comprise the speed of the aircraft, the maximum speed authorized in the holding circuit, characteristics specific to the model of the aircraft and the angle formed between the trajectory of the aircraft and a side of the HOLD comprising the entry point.

$$TAD = \vert {R}_{v} \cdot tan ( \frac{THETA}{2} ) \vert$$

Advantageously, the distance (RAD), computed in the third step, between the point for anticipating the turn and the start-of-turn point is a function of the airplane roll rate and of the nominal roll of the turn, the nominal roll of the turn being expressed by the following relation:

Advantageously, the distance, computed in the second step, between the point for anticipating the turn and the entry point to the HOLD is equal to

$$\vert arc tan ( \frac{{Groundspeed}^{2}}{Rv \cdot g} ) \vert$$

Advantageously, the avionics system comprises:
a navigation database, denoted NAVDB, making it possible to construct geographical routes and procedures on the basis of data included in the bases;
a performance database, denoted PRF DB, containing the craft's aerodynamic and engine parameters;
a computer, denoted FPLN, generating a flight plan and making it possible to enter the geographical elements constituting the skeleton of the route to be followed, said elements being stored in the navigation database;
a navigation computer, denoted LOCNAV, making it possible to perform aircraft location as a function of geo-location means;
a lateral trajectories computer, denoted TRAJ, which makes it possible to construct a continuous trajectory on the basis of the points of the flight plan that arise from the navigation database; and
a vertical trajectories computer, denoted PRED, making it possible to construct an optimized vertical profile on the lateral trajectory and data of the performance database.

Advantageously, an interface for managing the flight plan makes it possible to activate the computation of the optimal braking point according to the method of one of the preceding claims, a trajectory portion being generated between the optimal braking point and a point of the holding circuit.

### BRIEF DESCRIPTION OF THE DRAWINGS

Other characteristics and advantages of the invention will become apparent with the aid of the description which follows, given with regard to the appended drawings which represent:

FIG. 1 depicts a holding circuit rejoined by an aircraft according to an embodiment of the present invention;

FIG. 2 depicts joining up with a holding circuit according to an embodiment of the present invention.

### DETAILED DESCRIPTION

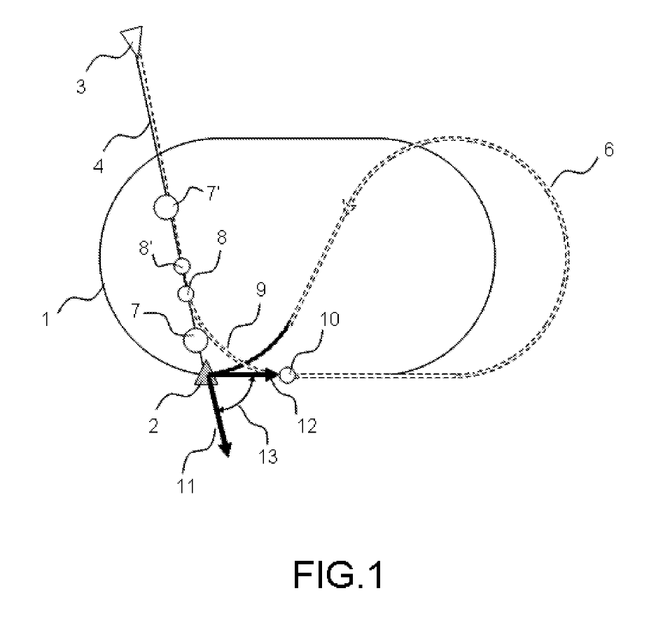

FIG. 1 represents a holding circuit 1, denoted HOLD, having the form of a racetrack. An aircraft 3, approaching the zone for example in which it will be induced to make its approach, steers toward the holding circuit 1. At this stage the air traffic control may or may not order the aircraft to over-fly the holding circuit. In the case where the air traffic control orders the crew of the aircraft to fly the holding circuit, it tells them an exit time corresponding for example to a landing time.

The approach trajectory comprising the trajectory portion 4 is then identical whether over-flight of the HOLD is or is not predicted. FIG. 1 represents two typical cases as regards the position of the points 7, 7′ of deceleration which delimits the portion 4 upstream of the approach trajectory. The points 7, 7′ correspond to two examples of position of points from which the aircraft begins to decrease its speed until the maximum speed authorized to fly the HOLD if the latter theoretically entered at the lock-on point 2. The deceleration points 7, 7′ can be computed at any moment.

Notably, within the framework of the invention, the aircraft no longer being required to over-fly the lock-on point 2 of the HOLD, the aircraft can theoretically commence a turn 9 allowing it to join up with the trajectory of the HOLD 1, if a directive originating from the air traffic control tells the aircraft to fly the holding circuit 1.

The invention makes it possible to compute the position of an optimal braking point, not represented in FIG. 1. The braking point on the one hand makes it possible to pass from the current speed of the aircraft to the maximum speed authorized to fly the HOLD and on the other hand to perform, as required, a turn 9 so as to comply with the entry of the aircraft into the HOLD, as defined in the RTCA standard DO236B. In the case where the aircraft performs a turn, the curvature of the turn 9 is notably dependent on airplane characteristics, on its speed and on the heading of the aircraft with respect to the orientation of the HOLD.

The method of the invention therefore makes it possible to compute the optimal braking point, on the basis of the characteristics of the aircraft, on the basis of which the aircraft must, when the latter is necessary, commence a turn 9 so as to enter the HOLD as simply as possible while complying with a speed limit in the HOLD.

The invention makes it possible to compute exactly the distance necessary both to ensure the latest possible deceleration and to guarantee proper following of the trajectory without overstepping the lock-on point 2.

So as to carry out the method of the invention, the aircraft comprises an avionics system comprising devices making it possible to implement the method.

Included among the devices of the avionics system are a computer, denoted FPLN, generating a flight plan and making it possible to enter the geographical elements constituting the skeleton of the route to be followed. Notably the departure and arrival procedures, the waypoints and the portions of aerial routes are taken into account in the generation of the flight plan.

The avionics system also comprises a navigation computer, denoted LOCNAV, making it possible to perform optimal location of the aircraft as a function of the geo-location means, such as the geo-location systems of GPS, GALILEO type or VHF radio beacons or else inertial platforms.

The avionics system also comprises a lateral trajectories computer, denoted TRAJ, which makes it possible to construct a continuous lateral trajectory on the basis of the points of the flight plan, complying with the airplane performance and the confinement constraints.

The avionics system also comprises a vertical trajectories computer, denoted PRED, making it possible to construct an optimized vertical profile on the lateral trajectory.

The avionics system also comprises aeronautical databases for generating the trajectories of the aircraft.

Notably, the avionics system comprises a navigation database, denoted NAVDB, making it possible to construct geographical routes and procedures on the basis of data included in the bases, such as points, beacons, interception LEGS or altitude.

The avionics system also comprises a performance database, denoted PRF DB, containing the craft's aerodynamic and engine parameters. It is notably used to compute the radii of curvature of the semicircles of the HOLDs of the altitude climb circuit.

The lateral trajectories computer TRAJ makes it possible to compute, according to the method of the invention, the change of course corresponding to the turn 9 and to the trajectory 6 making it possible to insert into the HOLD in proximity to the lock-on point 2.

Notably the method of the invention makes it possible to define a joining angle on the basis of a point 8 corresponding to the commencement of the turn and a point 10 of the HOLD where the aircraft joins up with the trajectory portion of the HOLD corresponding to one of its sides. A first vector 11 collinear with the trajectory of the aircraft upstream of the lock-on point and a second vector 12 collinear with a side of the HOLD make it possible to define a joining angle, denoted THETA, necessary in order to perform the transient turn so as to join up with the trajectory of the holding circuit.

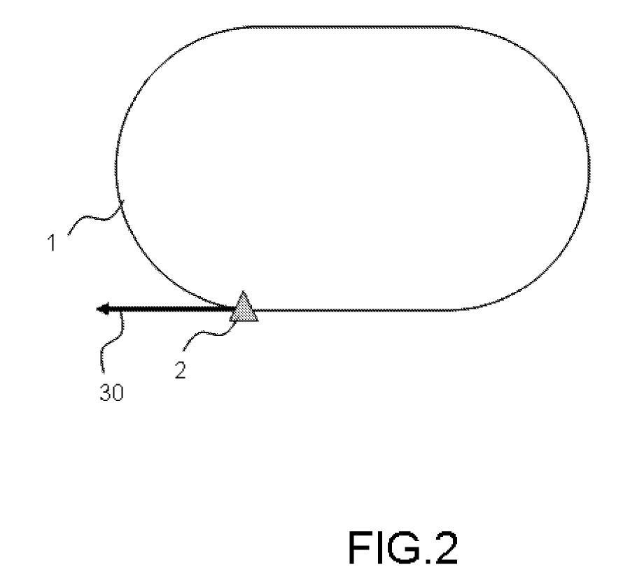

FIG. 2 represents a typical case where the aircraft originates from a heading substantially along the axis of a side of the HOLD comprising the lock-on point 2. The joining angle is then defined between the vector 30 which is in the same sense as the direction of the aircraft and the side of the HOLD comprising the lock-on point. The joining angle in this case is 0°.

Likewise, if the aircraft originates from a heading substantially along the axis of a side of the HOLD comprising the lock-on point but whose direction is opposite to the vector 30, then the joining angle is 180°.

The method of the invention makes it possible to determine, in a first step, the deceleration point 7 which is as close as possible to the lock-on point 2 and allowing the aircraft to brake theoretically up to the lock-on point 2 so as to reach the maximum speed authorized in the HOLD. The distance between the position of the lock-on point 2 and the position of the deceleration point 7 is denoted D_{deceleration}.

This deceleration point 7 is fixed by the constraint of the maximum limit speed of the HOLD and of the current speed of the aircraft.

In FIG. 1, two cases are represented according to the position of the deceleration point 7 or 7′ with respect to the position of the point 8, computed in the second step of the method. The point 8 corresponds to the point allowing the aircraft to perform its turn as late as possible while allowing it to join up with the holding circuit 1.

In a second step, the method of the invention makes it possible to compute, on the basis of the computer PRED as a function of the data delivered by the computer TRAJ, the position of the point 8 which allows the aircraft to perform a turn for joining up with the holding circuit as late as possible. The computation of the position of the point 8 depends on the airplane characteristics, on its current speed and on the approach heading of the aircraft. The distance between the point at which the joining turn starts and the point of entry to the HOLD being denoted TAD.

The third step of the method makes it possible to compute a position of a point for anticipating the turn 8′ making it possible to take into account the banking rate of the aircraft. The distance between the point for anticipating the turn and the point at which the joining turn starts being denoted RAD.

In this step, the method of the invention makes it possible to also compute the radius of the turn, denoted Rv, making it possible to commence joining up with the holding circuit 1.

Indeed, the time necessary for the aircraft to begin its turn is due to the banking rate of the aircraft. The method of the invention makes it possible to take into consideration the time necessary to begin the turn 9.

The position of the turn anticipation point TAD is computed as a function of the length of a side of the HOLD, of the joining angle and of data predicted by the computer PRED.

If the aircraft arrives along the axis of the side of the HOLD comprising the entry point, such as represented in FIG. 2, the value of the TAD is zero.

In the other typical cases the value of the TAD is determined by the absolute value of the product of the radius of the predicted turn and of the tangent of half the joining angle. We have:

$$TAD = \vert {R}_{v} \cdot tan ( \frac{THETA}{2} ) \vert$$

with Rᵥ the turning radius computed by the computers TRAJ and PRED.

The expression for RAD is expressed as a function dependent on the airplane roll rate and the nominal roll of the turn.

The nominal roll of the turn is defined by the expression:

$$\vert arc tan ( \frac{{GroundSpeed}^{2}}{Rv \cdot g} ) \vert .$$

In a fourth step, a margin, expressed as a distance, is computed. It makes it possible to take into account the real-time computation speed of the computers of the avionics system. This margin can be fixed by the pilot for example.

In a fifth step of the method of the invention, the computer PRED computes the optimal braking distance as the maximum value between on the one hand the value of the TAD plus the RAD and plus the additional margin and on the other hand the distance computed in the first step for decelerating up to the lock-on point. We have:

D_{braking}=MAX{TAD+RAD+m arg e;D_{deceleration}}

The added margin is necessary to take account of the real-time issues. Indeed, the computation of the entry transition is done at the moment of passing the deceleration point. Between the moment of instigating this computation and the moment when the trajectory is available, the airplane has advanced. It is therefore appropriate to adapt this margin to the computational capabilities of the system.

Finally the method of the invention comprises a sixth step making it possible on the basis of the FMS for example to generate a new portion of the flight plan joining the current trajectory of an aircraft on the approach to an airport to a holding circuit.

The generation of this trajectory portion comprises numerous advantages. Notably an advantage is that of optimizing the trajectory of the aircraft by consuming a minimum of fuel while maintaining the comfort of the crew.

The method also comprises the advantage of allowing the generation of the joining trajectory portion fairly rapidly while upholding safety margins so as not to overstep the holding circuit.

The many features and advantages of the invention are apparent from the detailed specification, and, thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and, accordingly, all suitable modifications and equivalents may be resorted to that fall within the scope of the invention.

What is claimed is:

1. A method for optimizing the computation of the position of the braking point on the approach to a holding circuit for aircraft, the holding circuit including an authorized maximum speed for the aircraft and a theoretical entry point, the aircraft approaching, at a first speed, according to a predefined trajectory intercepting the theoretical entry point of the holding circuit, the method comprising:
computing the optimal position of the theoretical deceleration point allowing the aircraft to pass from its current speed to the maximum speed authorized at the theoretical entry point while maintaining its trajectory so as to reach the theoretical entry point, the distance between the deceleration point and the theoretical entry point to the holding circuit called the deceleration distance denoted D_{deceleration};
computing a trajectory portion forming a turn allowing the aircraft to enter the holding circuit without necessarily passing through the theoretical entry point, and the position of the point of the start of the turn, the distance between the point of the start of turn and the theoretical entry point of the holding circuit being denoted TAD;
computing the position of a point for anticipating the turn, making it possible to take into account the banking rate of the aircraft, the distance between the point for anticipating the turn and the start-of-turn point denoted RAD;
computing a margin expressed as a distance taking into account the real-time computation speed of the computers of the avionics system; and
computing the start-of-braking point situated at a distance denoted D_{braking} from the theoretical entry point, for which:
D_{braking}=MAX{TAD+RAD+m arg e;D_{deceleration}}.

2. The method as claimed in claim 1, further comprising generating a new flight plan portion joining the start-of-braking point to a point of the holding circuit.

3. The method as claimed in claim 2, wherein said computing the trajectory forming a turn includes computing the radius of curvature of the turn for joining up with the holding circuit as a function of imposed constraints.

4. The method as claimed in claim 3, wherein the imposed constraints include the speed of the aircraft, the maximum speed authorized in the holding circuit, characteristics specific to the model of the aircraft and the angle formed between the trajectory of the aircraft and a side of the holding circuit comprising the entry point.

5. The method as claimed in claim 3, wherein the distance between the point for anticipating the turn and the entry point to the holding circuit is equal to:
$$TAD = \vert {R}_{v} \cdot tan ( \frac{THETA}{2} ) \vert$$
with THETA equal to the holding circuit joining angle and Rᵥ equal to the turning radius.

6. The method as claimed in claim 3, wherein the distance RAD between the point for anticipating the turn and the start-of-turn point is a function of the airplane roll rate and of the nominal roll of the turn, the nominal roll of the turn being expressed by:
$$\vert arc tan ( \frac{{GroundSpeed}^{2}}{Rv \cdot g} ) \vert$$

7. An avionics system, comprising:
a navigation database, denoted NAVDB, for constructing geographical routes and procedures on the basis of data included therein;
a performance database, denoted PRF DB, containing aircraft aerodynamic and engine parameters;
a computer, denoted FPLN, for generating a flight plan and for entering the geographical elements constituting the skeleton of the route to be followed, said elements being stored in the navigation database;
a navigation computer, denoted LOCNAV, for performing aircraft location as a function of geo-location means;
a lateral trajectories computer, denoted TRAJ, for constructing a continuous trajectory on the basis of the points of the flight plan that arise from the navigation database; and
a vertical trajectories computer, denoted PRED, for constructing an optimized vertical profile on the lateral trajectory and data of the performance database,
wherein an interface for managing the flight plan activates the computation of the optimal braking point according to the method of claim 1, a trajectory portion being generated between the optimal braking point and a point of the holding circuit.
